(19) United States
(12) Patent Application Publication
(10) Pub. No.: US 2009/0247702 A1
(43) Pub. Date: Oct. 1, 2009

(54) GAS BARRIER FILM

(75) Inventors: Jau-Rong Su, Kaohsiung City (TW); Tzer-Shun Yu, Ziguan Township (TW); Kuang-Cheng Chen, Ciaotou Township (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: TSRC Corporation, Taipei (TW)

(21) Appl. No.: 12/332,528

(22) Filed: Dec. 11, 2008

(30) Foreign Application Priority Data
Dec. 14, 2007 (TW) 096148034

(51) Int. Cl. C08L 53/02; C08L 25/06; C08L 25/10

(52) U.S. Cl. 525/98; 525/241; 525/95

(57) ABSTRACT

A film used for tires is provided. The film includes a thermoplastic elastomer, a polyolefin resin and a processing oil. The film has physical properties which are in a specific range. The air maintenance of a general tubeless tire would be improved after the film being adhered to the inside of the general tubeless tire. Furthermore, the general tire which the film adhered thereto would be provided with all the properties of a tubeless tire.

### FIELD OF THE INVENTION

The present invention relates to a gas barrier film for a tire, and more particularly to a gas barrier film including a thermoplastic elastomer (TPE) and welded by an ultrasonic welding process and/or a heat sealing process.

### BACKGROUND OF THE INVENTION

The tire is a necessary for the life. The functions of the tire, such as for supporting or transporting, are achievable only when the tire pressure of the tire is higher than a minimum pressure. However, since the minimum pressure must be higher than the atmospheric pressure, a gas filled in a tire, having a pressure higher than the minimum pressure, would be escaped from the tire if the tire is at rest for a period of time. In another situation, although a tire has the normal tire pressure and is using for supporting or transporting, where the tire pressure thereof would also decrease gradually. Accordingly, maintaining the tire pressure and extending the time for normal use of the tire are worthful for improving.

In various types of the tire, a general and traditional one is a tire configured therewithin an inner tube. The tire having the inner tube therein owns advantages as the simple structure and the cheap cost/price. However, this kind of tire has some defects that 1) the gas filled therein would be escaped immediately when the tire is punctured with a sharp obstacle such as a nail; 2) a malposition between the tire and the inner tube would cause the gas escaping from the valve; 3) the inner tube is easily incurred the “snake bite” after the tire is stricken; and 4) the riding by this kind of tires is laborious, etc. For solving the defects as mentioned above, the tubeless tire is developed. The tubeless tire is made of a specific tire which could work without the support of the inner tube by filling enough gas thereinto, whereby above-mentioned defects of the tire within the inner tube are solved. However, the tubeless tire is unideal for maintaining the gas filled therein. Moreover, since the materials and the structure of the tubeless tire are more complex than those of the tire within the inner tube and the tubeless tire must be configured with a specific rim, the cost of the tubeless tire is still expensive.

Employing experiments and researches full-heartily and persistently, the applicant finally conceived a preferable gas barrier film.

### SUMMARY OF THE INVENTION

The present invention provides a gas barrier film includes the TPE, and the gas barrier film is welded by ultrasonic welding and/or heat sealing so that the manufacturing process thereof would be more convenient. In addition, for a traditional tubeless tire, the ability for maintaining the gas filled therein would be improved apparently if the film of the present invention is adhered therein.

In accordance with one aspect of the present invention, a gas barrier film is provided. The gas barrier film includes a styrenic block copolymer (SBC) and has at least three properties each of which is selected from a group consisting of (1) a Shore A hardness from 1 A to 99 A, (2) a specific gravity from 0.8 to 1.5, (3) an ultimate tensile strength from 500 psi to 8000 psi, (4) a 300% modulus from 150 psi to 4600 psi and (5) an ultimate elongation from 250% to 1200%.

Preferably, the film further includes a polyolefin resin and a processing oil.

Preferably, the polyolefin resin is one selected from a group consisting of LDPE, HDPE, LLDPE, PP, EVA, EEA, EBA, EMA, EPR and a combination thereof.

Preferably, the processing oil is one selected from a group consisting of a naphthenic oil, an aromatic oil, a paraffinic oil and a combination thereof.

Preferably, the SBC is one selected from a group consisting of Styrene-Butadiene-Styrene (SBS), Styrene-Isoprene-Styrene (SIS), Styrene-Ethylene-Butylene-Styrene (SEBS), Styrene-Ethylene-Propylene-Styrene (SEPS), Styrene-Ethylene-Ethylene/Propylene-Styrene (SEEPS) and a combination thereof.

Preferably, the SBC, the polyolefin resin and the processing oil have weight percentages from 35% to 55%, from 15% to 30% and from 20% to 40% respectively.

Preferably, the film is processed by an extrusion process and welded by one of an ultrasonic welding process and/or a heat sealing process.

Preferably, the film is used on an inner wall of a tire.

In accordance with another one aspect of the present invention, a gas barrier coating is provided. The gas barrier coating includes a thermoplastic elastomer and has at least three properties each of which is selected from a group consisting of (1) a Shore A hardness from 1 A to 99 A, (2) a specific gravity from 0.8 to 1.5, (3) an ultimate tensile strength from 500 psi to 8000 psi, (4) a 300% modulus from 150 psi to 4600 psi and (5) an ultimate elongation from 250% to 1200%.

Preferably, the thermoplastic elastomer is a styrenic block copolymer (SBC).

Preferably, the thermoplastic elastomer further includes at lease one of a thermoplastic polyurethane (TPU) and a thermoplastic vulcanizates (TPV).

Preferably, the coating further includes a polyolefin resin and a processing oil.

Preferably, the polyolefin resin is one selected from a group consisting of LDPE, HDPE, LLDPE, PP, EVA, EEA, EBA, EMA, EPR and a combination thereof.

Preferably, the processing oil is one selected from a group consisting of a naphthenic oil, an aromatic oil, a paraffinic oil and a combination thereof.

Preferably, the SBC is one selected from a group consisting of Styrene-Butadiene-Styrene (SBS), Styrene-Isoprene-Styrene (SIS), Styrene-Ethylene-Butylene-Styrene (SEBS), Styrene-Ethylene-Propylene-Styrene (SEPS), Styrene-Ethylene-Ethylene/Propylene-Styrene (SEEPS) and a combination thereof.

Preferably, the SBC, the polyolefin resin and the processing oil have weight percentages from 35% to 55%, from 15% to 30% and from 20% to 40% respectively.

Preferably, the thermoplastic elastomer is a thermoplastic polyurethane (TPU).

Preferably, the coating is processed by an extrusion process and welded by one of an ultrasonic welding process and/or a heat sealing process.

Preferably, the coating is used on an inner wall of a tire.

In accordance with another one aspect of the present invention, a gas barrier coating is provided. The gas barrier coating includes a thermoplastic elastomer and has at least three properties each of which is selected from a group consisting of (1) a Shore A hardness from 1 A to 99 A, (2) a specific gravity from 0.8 to 1.5, (3) an ultimate tensile strength from 500 psi to 8000 psi, (4) a 100% modulus from 200 psi to 550 psi and (5) an ultimate elongation from 250% to 1200%.

Preferably, the thermoplastic elastomer is a thermoplastic vulcanizates (TPV).

Preferably, the thermoplastic elastomer includes a styrenic block copolymer (SBC) and at lease one of a thermoplastic polyurethane (TPU) and a thermoplastic vulcanizates (TPV).

Preferably, the coating is processed by an extrusion process and welded by one of an ultrasonic welding process and/or a heat sealing process.

Preferably, the coating is used on an inner wall of a tire.

In accordance with another one aspect of the present invention, a gas barrier film is provided. The gas barrier film includes a styrenic block copolymer (SBC), a polyolefin resin, a processing oil and at least one of a thermoplastic polyurethane (TPU) and a thermoplastic vulcanizates (TPV)

### DETAILED DESCRIPTION OF THE PREFERRED EMBODIMENT

In order to further illustrate the techniques, methods and efficiencies used to procure the aims of this invention, please see the following detailed descriptions. It is believable that the features and characteristics of this invention can be deeply and specifically understood by the descriptions. It is to be noted that the following descriptions of preferred embodiments of this invention are presented herein for the purposes of illustration and description only; it is not intended to be exhaustive or to be limited to the precise form disclosed.

The gas barrier film of the present invention is suitable for the traditional tubeless tube, where the inherent defects of the traditional tubeless tube as mentioned above could be modified by adhering the gas barrier film in the tubeless tube. Comparing with the traditional tubeless tube, the tubeless tube adhered therewithin the gas barrier film has a perfect ability for maintaining the filled gas. Moreover, since the manufacturing process of the gas barrier film is simple, the manufacturing cost thereof is quite low accordingly.

The SBC is a material that has both the properties of the rubber and the thermoplastic. The SBC is flexible at the room temperature and is thermoplastic at the high temperature. Accordingly, the SBC is a excellent material that has not only the mechanical and applied properties of the rubber but also advantages of the thermoplastic for easy process and modeling. The purpose of the polyolefin resin added into the raw materials of the present gas barrier film is mainly to improve the physical properties of the SBC. The purpose of the processing oil added into the raw materials of the present gas barrier film is mainly to improve the melt flow index of the SBC.

The summary steps of manufacturing the present gas barrier film are preheating, feeding and melting the raw materials, extruding the raw materials from the die plate and performing the cooling process and the rolling process. Finally, the gas barrier film would be welded by the ultrasonic welding process and/or the heat sealing process.

The values of physical properties of the present gas barrier films respectively made of various SBCs are shown in Tables 1 to 6, wherein the SBCs include the SBS, the SIS, the SEBS, the TPU and the TPV, and the polyolefin resin and the processing oil are optional raw materials when the SBC is selected from one of the SBS and the SEBS.

In Tables 1 to 6, several physical properties including the Shore A hardness, the specific gravity, the ultimate tensile strength, the 300% modulus and the ultimate elongation of each the gas barrier film are listed. The methods for measuring the mentioned physical properties are illustrated as follows.

The “Shore A hardness” is measured by a Shore durometer having a blunt indenter. The blunt indenter would firstly touch a surface of the present gas barrier film, and than the blunt indenter would be pushed into the surface by an appropriate and constant downward force exerted thereon. A depth caused by the blunt indenter pushed into the surface could be measured and converted into the Shore A hardness. The readings, i.e. the Shore A hardness, of 0 and 100 respectively indicate that the depths are 0.1 inch and 0 inch. Accordingly, the Shore A hardness of each the gas barrier film could be measured.

For measuring the “ultimate tensile strength” of the gas barrier film, a piece of the film is stretched until it breaks. The amount of the force needed to break the piece is then measured, namely the ultimate tensile strength. In the present invention, the unit of the ultimate tensile strength is given in pounds per square inch (psi).

For measuring the “300% modulus” of the gas barrier film in Tables 1 to 4, the measured film is stretched to three times the original length, and the resistance of the stretching, i.e. the 300% modulus, is measured. The 100% modulus test is another method often employed for measuring the physical properties of rubbers and flexible plastics. In Tables 5 and 6, the 100% modulus is also employed for showing the physical properties of several gas barrier films of the present invention. Both the units of the 300% modulus and the 100% modulus are given in pounds per square inch (psi).

The “ultimate elongation” in the Tables 1 to 6 means the maximum length of the gas barrier film before it breaks and is reported in percentage of the original length.

The raw materials of the gas barrier films shown in Tables 1 to 6 include the thermoplastic elastomer, the polyolefin resin and the processing oil have weight percentages from 35% to 55%, from 15% to 30% and from 20% to 40% respectively. Moreover, the thermoplastic elastomers in the present gas barrier films are the SBCs and optionally contains the TPU and/or the TPV. The SBC materials of the gas barrier films shown in Table 1 are various of SBSs and SEBSs produced by TSRC Corporation.

TABLE 1

| | | | ultimate | | |
|---|---|---|---|---|---|
| | Shore A | | tensile | 300% | ultimate |
| Gas Barrier | hardness | specific | strength | modulus | elongation |
| Film | (A) | gravity | (psi) | (psi) | (%) |
| Taipol-TPE | 76 | 0.91 | □3556 | □640 | 500 |
| SEBS 3150 | | | | | |
| Taipol-TPE | 76 | 0.91 | □2845 | □569 | 500 |
| SEBS 3152 | | | | | |
| Taipol-TPE | 77 | 0.95 | 2133 | 398 | 700 |
| SBS 3201 | | | | | |
| Taipol-TPE | 71 | 0.95 | 2133 | 398 | 750 |
| SBS 3202 | | | | | |
| Taipol-TPE | 92 | 0.96 | □2845 | — | □650 |
| SBS 4202 | | | | | |
| Taipol-TPE | 63 | 0.93 | 569 | 327 | 800 |
| SBS 4402 | | | | | |
| Taipol-TPE | 63 | 0.94 | 2845 | 156 | 1100 |
| SBS 475E | | | | | |
| Taipol-TPE | 85 | 0.94 | 1991 | 370 | 720 |
| SBS 411 | | | | | |
| T-Blend | 20 | 0.88 | 611 | 213 | 690 |
| TPE-F20 | | | | | |
| T-Blend | 28 | 0.89 | 540 | 227 | 740 |
| TPE-F30 | | | | | |
| T-Blend | 46 | 0.93 | 852 | 312 | 1000 |
| TPE-F45 | | | | | |
| T-Blend | 50 | 0.91 | 426 | 398 | 500 |
| TPE-F50 | | | | | |
| T-Blend | 62 | 1.07 | 653 | — | 184 |
| TPE-F60 | | | | | |
| T-Blend | 66 | 0.93 | 724 | 568 | 450 |
| TPE-F65 | | | | | |
| T-Blend | 70 | 0.91 | 1235 | 73 | 400 |
| TPE-F70 | | | | | |
| T-Blend | 78 | 1.13 | 880 | 781 | 480 |
| TPE-F78 | | | | | |
| T-Blend | 81 | 0.89 | 1179 | 795 | 540 |
| TPE-F80 | | | | | |
| T-Blend | 92 | 1.13 | 1860 | — | 150 |
| TPE-F90 | | | | | |
| T-Blend | 94 | 0.89 | 1832 | 1221 | 620 |
| TPE-F95 | | | | | |

In Table 2, the SBC materials of the gas barrier films shown therein contain various of TPUs produced by Great Eastern Resins Industrial CO., LTD. (GRECO).

TABLE 2

| | | | ultimate | | |
|---|---|---|---|---|---|
| | Shore A | | tensile | 300% | ultimate |
| Gas Barrier | hardness | specific | strength | modulus | elongation |
| Film | (A) | gravity | (psi) | (psi) | (%) |
| ISOTHANE ® | 85 | 1.18 | 5500 | 1800 | 580 |
| 1085A | | | | | |
| ISOTHANE ® | 92 | 1.20 | 5800 | 3300 | 500 |
| 2090A | | | | | |
| ISOTHANE ® | 94 | 1.20 | 6100 | 3600 | 480 |
| 2095A | | | | | |
| ISOTHANE ® | 97 | 1.21 | 6300 | 4400 | 450 |
| 2098A | | | | | |

In Table 3, the SBC materials of the gas barrier films shown therein contain various of TPUs produced by Bayer Material Science.

TABLE 3

| | | | ultimate | | |
|---|---|---|---|---|---|
| | Shore A | | tensile | 300% | ultimate |
| Gas Barrier | hardness | specific | strength | modulus | elongation |
| Film | (A) | gravity | (psi) | (psi) | (%) |
| Desmopan 786E | 88 | 1.15 | 6235 | 2030 | 525 |
| Desmopan 588E | 88 | 1.15 | 5075 | 1595 | 600 |
| Desmopan 385E | 85 | 1.2 | 7250 | 1885 | 500 |
| Desmopan 3385A | 85 | 1.2 | 7250 | 2175 | 500 |
| Desmopan | 86 | 1.2 | 7250 | 1885 | 450 |
| DP3685AU | | | | | |
| Desmopan | 93 | 1.21 | 7975 | 3480 | 430 |
| DP3690AU | | | | | |

In Table 4, the SBC materials of the gas barrier films shown therein contain various of TPUs produced by BASF.

TABLE 4

| | | | ultimate | | |
|---|---|---|---|---|---|
| | Shore A | | tensile | 300% | ultimate |
| Gas Barrier | hardness | specific | strength | modulus | elongation |
| Film | (A) | gravity | (psi) | (psi) | (%) |
| Elastollan ® | 80 | 1.11 | 4700 | 1700 | 600 |
| 1180A10 | | | | | |
| Elastollan ® | 86 | 1.12 | 4800 | 3000 | 640 |
| 1185A10 | | | | | |
| Elastollan ® | 86 | 1.12 | 4800 | 3000 | 640 |
| 1185A10U | | | | | |
| Elastollan ® | 91 | 1.13 | 5300 | 4500 | 575 |
| 1190A10 | | | | | |

In Table 5, the SBC materials of the gas barrier films shown therein contain various of TPVs produced by Solvay Engineered Polymers.

TABLE 5

| | | | ultimate | | |
|---|---|---|---|---|---|
| | Shore A | | tensile | 100% | ultimate |
| Gas Barrier | hardness | specific | strength | modulus | elongation |
| Film | (A) | gravity | (psi) | (psi) | (%) |
| NexPrene ® | 51 | 0.97 | 943 | 319 | 427 |
| 1055A | | | | | |
| NexPrene ® | 56 | 0.97 | 1015 | 348 | 500 |
| 1060A | | | | | |
| NexPrene ® | 59 | 0.97 | 1102 | 392 | 540 |
| 1064A | | | | | |
| NexPrene ® | 63 | 0.96 | 1160 | 406 | 510 |
| 1067A | | | | | |
| NexPrene ® | 66 | 0.97 | 1262 | 450 | 611 |
| 1070A | | | | | |
| NexPrene ® | 71 | 0.97 | 1450 | 522 | 631 |
| 1075A | | | | | |

In Table 6, the SBC materials of the gas barrier films shown therein contain various of TPVs produced by Nantex Industry Co., Ltd.

TABLE 6

| | | | ultimate | | |
|---|---|---|---|---|---|
| | Shore A | | tensile | 100% | ultimate |
| Gas Barrier | hardness | specific | strength | modulus | elongation |
| Film | (A) | gravity | (psi) | (psi) | (%) |
| Dynaprene ®VE0055A | 55 | 0.96 | 650 | 210 | 390 |
| Dynaprene ®VE0064A | 64 | 0.96 | 910 | 330 | 410 |
| Dynaprene ®VE0073A | 73 | 0.96 | 1100 | 420 | 480 |
| Dynaprene ®VE1055A | 55 | 0.95 | 510 | 210 | 300 |
| Dynaprene ®VE1064A | 64 | 0.95 | 590 | 270 | 310 |
| Dynaprene ®VE1073A | 73 | 0.95 | 830 | 348 | 380 |

Table 7 shows the changes of the tire pressures of traditional tubeless tires and identical ones to the traditional tubeless tire but respectively adhered therewithin the gas barrier film of the present invention (hereinafter called the improved tubeless tire), where all the tires are at rest for several days.

TABLE 7

| | |
|---|---|
| Tire pressure | days for being at rest (day) |

| (psi/average) | traditional tubeless tire | improved tubeless tire |
|---|---|---|
| 80 | 0 | 0 |
| 40 | 2 | 20 |
| 39 | 20 | 75 |

For measuring the tire pressures shown in Table 7, the traditional and the improved tubeless tires are respectively filled the gas until the respective tire pressures are 80 psi. Then, all the tires are at rest for a period of time, and changes of the tire pressures of the tires are measured and recorded. As shown in Table 7, the tire pressures of the traditional tubeless tires averagely decrease from 80 psi to 40 psi spending only two days and further averagely decrease to 39 psi at 20^{th} day. However, the tire pressures of the improved tubeless tires averagely decrease from 80 psi to 40 psi until 20^{th} day, which reveals an excellent ability of the gas barrier film for maintaining the tire pressure. Moreover, until 75^{th} day, the tire pressures of the improved tubeless tires averagely decrease from 80 psi to 39 psi, where the excellent ability for maintaining the tire pressure is improved again.

Based on the above-mentioned illustrations, it is clearly known that the gas barrier film of the present invention has outstanding performance for maintaining the tire pressure. By simply adhering the gas barrier film of the present invention into the traditional tubeless tube, the ability thereof for maintaining the tire pressure would be increased apparently. Moreover, the cost for enhancing the properties of the traditional tubeless tire could be decreased accordingly.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims, which are to be accorded with the broadest interpretation so as to encompass all such modifications and similar structures. Therefore, the above description and illustration should not be taken as limiting the scope of the present invention which is defined by the appended claims.

What is claimed is:

1. A gas barrier film comprising a styrenic block copolymer (SBC), wherein the film has at least three properties each of which is selected from a group consisting of (1) a Shore A hardness from 1 A to 99 A, (2) a specific gravity from 0.8 to 1.5, (3) an ultimate tensile strength from 500 psi to 8000 psi, (4) a 300% modulus from 150 psi to 4600 psi and (5) an ultimate elongation from 250% to 1200%.

2. The gas barrier film according to claim 1, wherein the film further comprises a polyolefin resin and a processing oil.

3. The gas barrier film according to claim 2, wherein the SBC, the polyolefin resin and the processing oil have weight percentages from 35% to 55%, from 15% to 30% and from 20% to 40% respectively.

4. The gas barrier film according to claim 2, wherein the polyolefin resin is one selected from a group consisting of a LDPE, a HDPE, a LLDPE, a PP, an EVA, an EEA, an EBA, an EMA, an EPR and a combination thereof.

5. The gas barrier film according to claim 2, wherein the processing oil is one selected from a group consisting of a naphthenic oil, an aromatic oil, a paraffinic oil and a combination thereof.

6. The gas barrier film according to claim 1, wherein the SBC is one selected from a group consisting of a Styrene-Butadiene-Styrene (SBS), Styrene-Isoprene-Styrene (SIS), a Styrene-Ethylene-Butylene-Styrene (SEBS), a Styrene-Ethylene-Propylene-Styrene (SEPS), a Styrene-Ethylene-Ethylene/Propylene-Styrene (SEEPS) and a combination thereof.

7. The gas barrier film according to claim 1, wherein the film is processed by an extrusion process and welded by one of an ultrasonic welding process and/or a heat sealing process.

8. The gas barrier film according to claim 1, wherein the film is used on an inner wall of a tire.

9. A gas barrier coating comprising a thermoplastic elastomer, wherein the coating has at least three properties each of which is selected from a group consisting of (1) a Shore A hardness from 1 A to 99 A, (2) a specific gravity from 0.8 to 1.5, (3) an ultimate tensile strength from 500 psi to 8000 psi, (4) a 300% modulus from 150 psi to 4600 psi and (5) an ultimate elongation from 250% to 1200%.

10. The gas barrier coating according to claim 9, wherein the thermoplastic elastomer is a styrenic block copolymer (SBC).

11. The gas barrier coating according to claim 10, wherein the thermoplastic elastomer further comprises at lease one of a thermoplastic polyurethane (TPU) and a thermoplastic vulcanizates (TPV).

12. The gas barrier coating according to claim 11, wherein the coating further comprises a polyolefin resin and a processing oil.

13. The gas barrier film according to claim 12, wherein the polyolefin resin is one selected from a group consisting of a LDPE, a HDPE, a LLDPE, a PP, an EVA, an EEA, an EBA, an EMA, an EPR and a combination thereof, and the processing oil is one selected from a group consisting of a naphthenic oil, an aromatic oil, a paraffinic oil and a combination thereof.

14. The gas barrier coating according to claim 12, wherein the SBC, the polyolefin resin and the processing oil have weight percentages from 35% to 55%, from 15% to 30% and from 20% to 40% respectively.

15. The gas barrier coating according to claim 9, wherein the thermoplastic elastomer is a thermoplastic polyurethane (TPU).

16. The gas barrier coating according to claim 9, wherein the film is used on an inner wall of a tire.

17. A gas barrier coating comprising a thermoplastic elastomer, wherein the coating has at least three properties each of which is selected from a group consisting of (1) a Shore A hardness from 1 A to 99 A, (2) a specific gravity from 0.8 to 1.5, (3) an ultimate tensile strength from 500 psi to 8000 psi, (4) a 100% modulus from 200 psi to 550 psi and (5) an ultimate elongation from 250% to 1200%.

18. The gas barrier coating according to claim 17, wherein the thermoplastic elastomer is a thermoplastic vulcanizates (TPV).

19. The gas barrier coating according to claim 17, wherein the thermoplastic elastomer comprises a styrenic block copolymer (SBC) and at lease one of a thermoplastic polyurethane (TPU) and a thermoplastic vulcanizates (TPV).

20. A gas barrier film, comprising a styrenic block copolymer (SBC), a polyolefin resin, a processing oil and at least one of a thermoplastic polyurethane (TPU) and a thermoplastic vulcanizates (TPV).
